(19) United States
(12) Patent Application Publication
(10) Pub. No.: US 2006/0002329 A1
(43) Pub. Date: Jan. 5, 2006

(54) Method and system for providing backward compatibility between protocol for carrying authentication for network access (PANA) and point-to-point protocol (PPP) in a packet data network

(76) Inventor: Lila Madour, Kirkland (CA)

Correspondence Address: ALEX NICOLAESCU;Ericsson Canada Inc., Patent Department (EMC/QM/P), 8400 Decarie Blvd., Town Mount Royal, QC, H4P 2N2, CA

(21) Appl. No.: 11/008,916

(22) Filed: Dec. 13, 2004

Related U.S. Application Data
(60) Provisional application No. 60/584,160, filed on Jul. 1, 2004.

(51) Int. Cl. H04Q 7/00

(52) U.S. Cl. 370/328

(57) ABSTRACT

The invention relates to a method and a base station controller (BSC) for providing network access to mobile terminals (MTs) in a packet data network that uses Protocol for Carrying Authentication for Network Access (PANA) and Point-to-Point Protocol (PPP) simultaneously. The method performs at the BSC a selection algorithm at the BSC for selecting from a first list of IP addresses of PANA capable PDSNs and a second list of point-to-point protocol (PPP) capable PDSNs a PDSN for serving the MT. The selection algorithm is based on a MT PANA capability indicator previously received at the BSC.

### PRIORITY STATEMENT UNDER 35 U.S.C S.119 (e) & 37 C.F.R. S.1.78

This non-provisional patent application claims priority based upon the prior U.S provisional patent applications entitled “QSA: PPP free Operation”, application 60/584,160 filed Jul. 1, 2004, in the name of Lila Madour.

### BACKGROUND OF THE INVENTION

1. Field of the Invention

The invention relates to a method and a node for providing backward capability to a mobile terminal in a third generation (3G) cellular telecommunications network.

2. Description of the Related Art

As of today, in a third generation (3G) cellular telecommunications network, direct access to the Internet is provided to mobile users of mobile terminals (MTs) via a gateway such as a Packet Data Serving Node (PDSN) in a Code Division Multiple Access 2000 (CDMA2000) network or a Mobile Switching Center/General Packet Radio Service Support Node (MSC/GSN) in a Global System Mobile/General Packet Radio Service (GSM/GPRS) network. The Point-to-Point Protocol (PPP) is first used to configure the traffic channel between a MT and the gateway of the cellular telecommunications network node and subsequently to transport network layer protocol data units (PDU) over the traffic channel. Since PPP was initially designed to run over the wire, it normally requires numerous exchanges of signaling messages between the two peers to configure their connection, namely LCP, IPCP, etc.

CDMA2000 network is taken into consideration for describing the utilization of PPP but it could be understand that this description could be applied to any 3G cellular networks. PPP is used for setting up data session between the MTs and the serving PDSN. PPP is a protocol for communication between two nodes using a serial interface. PPP uses the Internet Protocol (IP) and thus it is sometimes considered a member of the TCP/IP suite of protocols. Relative to the Open Systems Interconnection (OSI) reference model, PPP provides layer 2 (data-link layer) services. Essentially, it packages a computer's TCP/IP packets and forwards them to a server where they can actually be put on the Internet. The use of PPP in CDMA2000 networks is defined in the Internet Engineering Task Force (IETF) Request for Comments (RFC) 1661, which is herein included by reference in its entirety, as a link layer protocol between the MT and the PDSN for the establishment of packet data sessions (PPP session). In CDMA2000 networks, four types of packet data sessions may be established using PPP: Simple IPv4, Mobile IPv4, Simple IPv6 and Mobile IPv6, on which work in still in progress.

Recently, the 3G Partnership Project 2 (3GPP2) has accepted a work item that proposes elimination of PPP from the CDMA2000 packet data system and its replacement with an IP level signaling for at least the following motivations:
PPP is a very old technology mainly designed for wire-line dial-up services and 3GPP2 is considering upgrading to a better-suited protocol;
High-Level Data Link Control (HDLC) like framing is a processor intensive task: according to a study made by Qualcomm Inc. for broadcast multicast service, HDLC-like framing is 62 times more computational intensive compared to packet based framing, which has been adopted as an option to support broadcast/multicast service in 3GPP2. The MT and the PDSN utilize a processor intensive procedure whereby they parse received data on an octet-by-octet basis for HDLC flags to determine higher layer packet boundaries. This operation could be rather performed at a hardware level. However, this requires the platform hardware to support HDLC, which is not the case with current PDSNs; and
PPP is based on peer-to-peer negotiation, which may cause high call setup delay times. According to a recent benchmark, the average PPP call setup time is about 2.5 seconds, which is inappropriate for most applications used in CDMA2000 networks.

However, there is no other existing IETF-based protocol that provides all the capabilities of PPP, i.e. link layer negotiation, MT discovery, header compression negotiation, DNS IP address configuration, packet data session termination, backward compatibility and link layer echo test. Other protocols have recently been identified as IP access based protocols that may represent an alternative to PPP, but each one lacks one or more of the capabilities of PPP.

Recently, the IETF has considered using the Protocol for Carrying Authentication for Network Access (PANA) as one of these possible replacements for PPP for setting up data sessions in CDMA2000 networks. PANA involves two entities, a PANA Authentication Client (PAC) in the MT and a PANA Authentication Agent (PAA) in the PDSN. An Enforcement point (EP) is just an Access Router that provides per packet enforcement policies applied on the inbound and outbound traffic of the MT, although in some case the EP may be implemented in the PDSN itself. PANA, as defined today in the IETF draft, is limited to carry Extensible Authentication Protocol (EAP) authentication between the PAC and the AAA through the PAA. Any EAP method can be transported, including the methods that allow bootstrapping for other protocols in the access network for encryption and data integrity, if so required by the operator.

It is known that in most cases access networks require some form of authentication in order to prevent unauthorized usage. In the absence of physical security (and sometimes in addition to it), a higher layer (L2+) access authentication mechanism is needed. Depending on the deployment scenarios, a number of features are expected from the authentication mechanism. For example, support for various authentication methods (e.g., MD5, TLS, SIM, etc.), network roaming, network service provider discovery and selection, separate authentication for access (L1+L2) service provider and Internet Service Provider (ISP, L3), etc. In the absence of a link-layer authentication mechanism that can satisfy these needs, operators are forced to either use non-standard ad-hoc solutions at layers above the link, insert additional shim layers for authentication, or misuse some of the existing protocols in ways that were not intended by design. PANA is proposed to be developed to fill this gap by defining a standard network-layer access authentication protocol. As a network-layer access authentication protocol, PANA can be used over any link-layer that supports IP.

PPP-based authentication could provide some of the required functionality. But using PPP only for authentication is not a good choice, as it incurs additional messaging during the connection setup and extra per-packet processing, and it forces the network topology to a point-to-point model. Aside from resistance to incorporating PPP into architecture in absence of any other suitable protocol, there is now an interest in the CDMA2000 community to remove PPP from some of the existing architectures and deployments.

The goal of PANA is to define a protocol that allows clients, such as MTs of a CDMA2000 network, to be “discovered” by the serving node and be authenticated with the access network using IP protocols. Such a protocol would allow a client to interact with an AAA infrastructure to gain access without needing to understand the particular AAA infrastructure protocols that are in use at the site. It would also allow such interactions to take place without a link-layer specific mechanism. PANA would be applicable to both multi-access and point-to-point links. It would provide support for various authentication methods, dynamic service provider selection, and roaming clients. Mobile IPv4 developed its own protocols for performing PANA-like functions (e.g., MT-Foreign Agent (FA) interaction). Mobile IPv6 does not have the equivalent of an FA that would allow the access/visited network to authenticate the MT before allowing access. The PAA can perform the authentication function attributed to the FA in Mobile IPv4, in Mobile IPv6 networks. Work is currently being performed with PANA with the assumption that a PAC is already configured with an IP address before using PANA. This IP address will provide limited reachability to the PAC until it is authenticated with the PAA. Upon successful authentication, the PAC is granted broader network access possibly by either a new IP address assignment, or by enforcement points changing filtering rules for the same IP address.

In order to better understand the use of PANA, a short explanation of the PANA usual terminology may be appropriate:

PANA Session:

A PANA session begins with the initial handshake between the PANA Client (PAC) and the PANA Authentication Agent (PAA), and terminates by an authentication failure, a timeout, or an explicit termination message. A fixed session identifier is maintained throughout a session. A session cannot be shared across multiple physical network interfaces. A distinct PANA session is associated with the device identifiers of PAC and PAA.

Session Identifier:

This identifier is used to uniquely identify a PANA session on the PAA and PAC. It includes an identifier of the PAA, therefore it cannot be shared across multiple PAAs. It is included in PANA messages to bind the message to a specific PANA session. This bi-directional identifier is allocated by the PAA following the initial handshake and freed when the session terminates.

PANA Security Association:

A PANA security association is a relationship between the PAC and PAA, formed by the sharing of cryptographic keying material and associated context. Security associations are duplex. That is, one security association is needed to protect the bi-directional traffic between the PAC and the PAA.

PANA Client (PAC):

The client side of the protocol that resides in the host device, which is responsible for providing the credentials to prove its identity for network, access authorization.

PANA Authentication Agent (PAA):

The protocol entity in the access network side whose responsibility is to verify the credentials provided by a PANA client and grant network access service to the device associated with the client and identified by a DI. Note the authentication and authorization procedure can, according to the EAP model, be also offloaded to the backend AAA infrastructure.

PPP and PANA are protocols different one to another, but they need to co-exist in (3G) cellular telecommunications network. Clients such as MT may support only one of the two network access procedures (PANA and PPP). Furthermore, packet data networks may comprise network elements that support only PANA or PPP. For that reason, backward compatibility for PPP capable MTs is necessary.

For that reason, there is a need to provide a solution for providing network access for PANA client and PPP clients in an access network that provides PANA and PPP network access procedures. The invention provides a solution to that problem.

### SUMMARY OF THE INVENTION

It is therefore one broad object of this invention to provide a method for providing network access to a mobile terminal (MT) in a packet data network, the method comprises steps of:
receiving at a base station controller (BSC) from the MT an origination request for requesting packet data services in the packet data network, the origination request including the identity of the MT;
sending from the BSC to a mobile centralized database of the MT an authorization/authentication request that includes the identity of the MT;
receiving at the BSC from the mobile centralized database an authorization/authentication response, the authorization/authentication response including a MT protocol for carrying authentication for network access (PANA) capability indicator, wherein the MT PANA capability indicator indicates whether or not the MT is PANA capable;
performing a selection algorithm at the BSC for selecting from a first list of IP addresses of PANA capable PDSNs and a second list of point-to-point protocol (PPP) capable PDSNs a PDSN for serving the MT:
   determining, based on the received MT PANA capability indicator, whether or not the MT is PANA capable;
   if the MT PANA indicator indicates that the MT is PANA capable, the BSC selects a PANA capable PDSN from the first list; and
   if the MT PANA indicates that the MT is not PANA capable, the BSC selects a PPP capable PDSN from the second list.
      It is therefore one broad object of this invention to provide

It is therefore one broad object of this invention to provide a base station controller (BSC) for selecting a packet data serving node (PDSN), wherein the base station comprises:

a service logic adapted for:
receiving at the BSC from the mobile centralized database an authorization/authentication response, the authorization/authentication response including a MT protocol for carrying authentication for network access (PANA) capability indicator, wherein the MT PANA capability indicator indicates whether or not the MT is PANA capable;

a database adapted for:
storing a first list of PANA capable PDSN and a second list of PPP capable PDSN;

wherein the service logic performs a selection algorithm at the BSC for selecting a PDSN from a first list of IP addresses of PANA capable PDSNs and a second list of PPP capable PDSNs, wherein the selection is based on the received MT PANA capability indicator:
if the MT PANA indicator indicates that the MT is PANA capable, the service logic selects a PANA capable PDSN from the first list; and
if the MT PANA indicator does not indicate that the MT is PANA capable, the service logic selects a PPP capable PDSN from the second list.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a nodal operation and signal flow diagram illustrating a flow of messages of a method for providing network access to a mobile terminal (MT) when a PDSN supports only Protocol for Carrying Authentication for Network Access (PANA) or only Point-to-Point Protocol (PPP) network access in a packet data network in accordance to the invention;

FIG. 2 is a nodal operation and signal flow diagram illustrating a flow of messages of a method for providing network access to a mobile terminal (MT) when a PDSN supports both PANA network access and PPP network access in a packet data network in accordance to the invention;

FIG. 3 is a schematic diagram illustrating a BSC for selecting a PDSN and further a schematic diagram illustrating a mobile centralized database for storing MTs profiles in accordance to the invention.

### DETAILED DESCRIPTION OF THE PREFERRED EMBODIMENTS

The network access to a packet data network may be provided by a gateway such as a Packet Data Serving Node for a CDMA2000 network. Advantageously a network operator may decide based on economical reasons to deploy only PANA capable PDSN instead of upgrading existing PPP capable PDSN. As a result, PANA only capable PDSNs would be deployed together with existing PPP only capable PDSNs. Consequently, an appropriate PDSN selection is necessary at a Radio Access Network (RAN) for providing access to PANA capable MTs and PPP capable MTs.

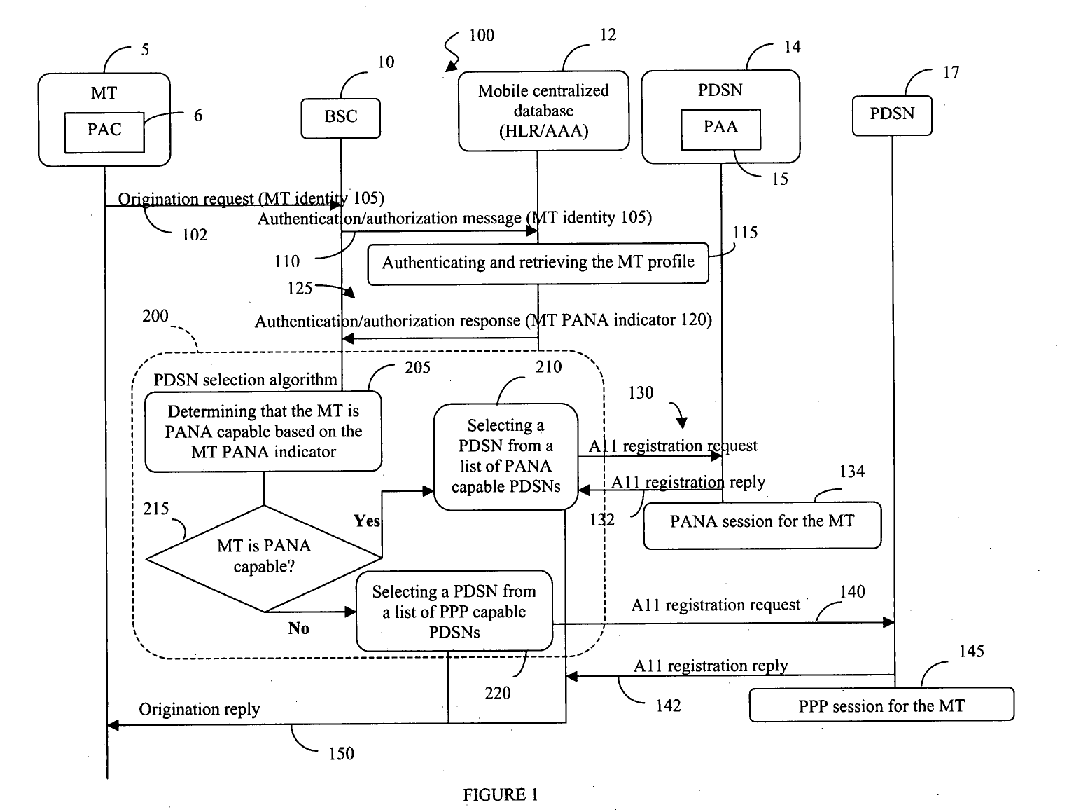

Reference is now made to FIG. 1, which is a nodal operation and signal flow diagram illustrating a flow of messages of a method for providing network access to a mobile terminal (MT) 5 when a PDSN supports only Protocol for Carrying Authentication for Network Access (PANA) or only Point-to-Point Protocol (PPP) network access in a packet data network in accordance to the invention.

The MT 5 can be a mobile station, a mobile telephone a personal data application, or any mobile equipment that can receive signal from the packet data network 100. The MT 5 comprises a PANA Client (PAC) 6 for supporting PANA network access. Thus, this means that the MT 5 can access the packet data network 100 and ultimately a network such as Internet following a PANA session.

The packet data network 100 can be any third generation (3G) cellular telecommunications network that allows a subscriber of the MT 5 to communicate via a packet data network such as a Code Division Multiple Access (CDMA2000 ) network or a Global System Mobile/General Packet Radio Service (GSM/GPRS). Furthermore, the packet data network 100 comprises a Base Station Controller BSC 10, a mobile centralized database 12, a PANA capable Packet Data Serving Node (PDSN) 14 and a PPP capable PDSN 17, PDSNs 14 and 17 are each a point of entry into the packet data network 100. The PDSN 14 comprises a PANA Authentication Agent (PAA) 15 for establishing a PANA session with a MT that comprises a PANA Client (PAC). The PDSNs performs two basic functions as follows: 1) Exchanging packets with the MT 5 via the BSC 10 and 2) Exchanging packets with other IP networks so as to provide authentication of the MT 5. The PANA capable PDSN 14 and the PPP capable PDSN 17 each support a network access procedure based on two different packet data protocols namely the PPP network access protocols and the PANA network access protocol.

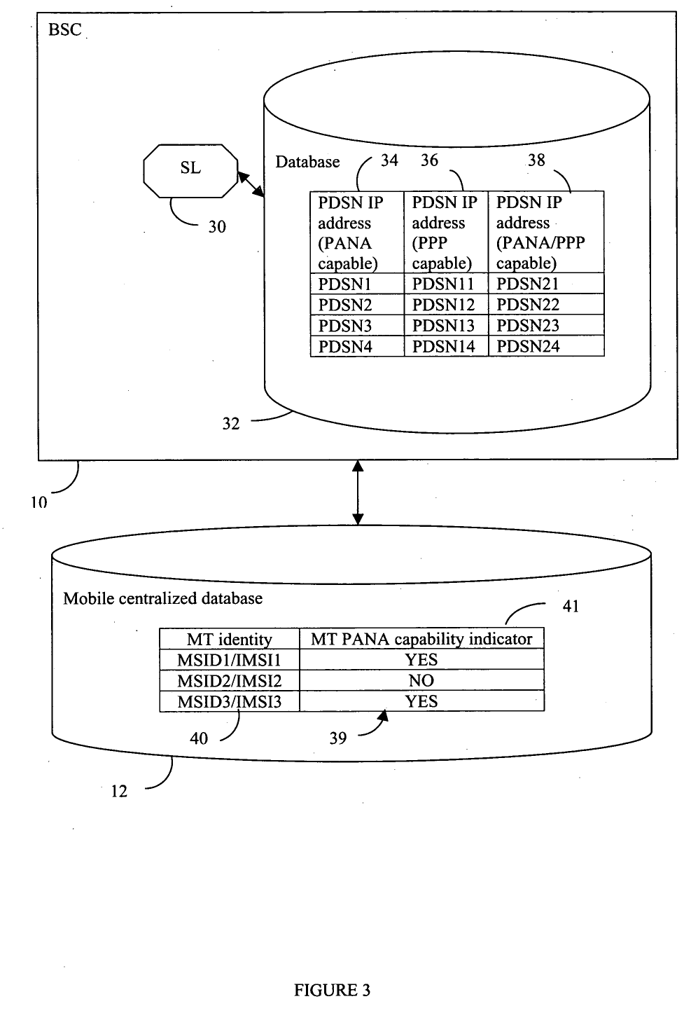

Reference is now made to FIG. 3, which is a schematic diagram illustrating the BSC 10 for selecting a PDSN and further a schematic diagram illustrating the mobile centralized database 12 for storing MTs profiles 39 in accordance to the invention.

The mobile centralized database 12 stores MT profiles 39 and particularly MT PANA capability indicators 41 as part of MT profiles 39 and associated with MT identity 40 of MTs. The MT PANA capability indicators 41 indicate whether or not a MT is PANA capable. The mobile centralized database 12 provides that information to authorized network entities such as the BSC 10. The mobile centralized database 12 can be a Home Location Register (HLR) in a CDMA2000 network or an Access Network—Authentication, Authorization, and Accounting (AN-AAA) server in a 1xEV-DO known as a High Rate Packet Data (HRPD) network for providing routing capabilities and for handling authentication for the MT 5.

The BSC 10 is the control part of a Radio Base Station (RBS) (not shown). A BS is a central radio transmitter/receiver that maintains communications with the MT. The BS usually covers a given range (typically a cell) for MTs. The BSC 10 controls one or more RBSs radio signals, thus reducing the load on a Mobile Switching Center (MSC) (not shown). The BSC 10 also performs radio signal management functions for RBSs and manages functions such as frequency assignment and handoff.

The BSC 10 comprises a service logic (SL) 30 and an internal database 32. The SL 30 is adapted to receive and send messages in the packet data network 100, the SL 30 also operates the BSC 10 and accesses the internal database 32. The SL 30 can be a software, a hardware or any combination thereof. The internal database 32 stores a first list 34 of IP addresses of PANA only capable PDSNs and a second list 36 of IP addresses of PPP only capable PDSNs and a third list 38 of IP addresses of PANA/PPP capable PDSNs. The BSC 10 interacts with the mobile centralized database 12 and further with a PDSN (PDSN 14 or PDSN 17) for providing network access to the MT 5 in the packet data 100 and ultimately to a network such as Internet.

In FIG. 1, the MT 5 sends an Origination request 102 to the BSC 10 to request packet data service. The Origination request 102 includes a MT identity parameter 105 of the MT 5. The identity 105 of the MT 5 may be its International Mobile Subscriber Identity (IMSI) or its Mobile Station Identifier (MSID). Following the reception of the Origination request 102, the BSC 10 sends an Authorization/authentication message 110 that includes the identity 105 of the MT 5. At step 115, the mobile centralized database 12 authenticates the MT 5, based on the MT identity 105 authenticates the MT 5 and retrieves from a MT profile 39 a MT PANA capability indicator 120 of the MT 5. The MT PANA capability indicator 120 indicates whether or not the MT 5 is PANA capable. Next, the mobile centralized database 12 sends an Authorization/authentication response 125.

Upon receiving the Authorization/authentication response 125, the BSC 10 performs a selection algorithm 200 for selecting a PDSN for serving the MT 5. The PDSN selection 200 is performed at the BSC 10 by the SL 30, which accesses the first list 34 of IP addresses of PANA capable PDSNs and the second list 36 of point-to-point protocol (PPP) capable PDSNs, wherein the selection is based on the received MT PANA capability indicator. At step 205, the SL 30 determines whether or not the MT 5 is PANA capable. At step 215, if the MT PANA indicator 120 indicates that the MT 5 is PANA capable, the BSC 10 selects a PANA capable PDSN (PDSN 14) from the first list 34 (step 210) and sends an A11 registration request 130 for requesting packet data services and for granting network access to the MT 5. The PDSN 14 replies to the A11 registration request 130 and sends an A11 Reply 132. At step 134, the PDSN 14 starts a PANA session for the MT 5.

Alternatively, at step 215, if the MT PANA indicator 120 indicates that the MT 5 is not PANA capable, the BSC 10 selects a PPP capable PDSN (PDSN 17) from the second list 36 (step 220) and sends an A11 Request 140 for requesting packet data services and for granting network access to the MT 5. The PDSN 17 replies to the A11 Request 140 and sends an A11 Reply 142. At step 134, the PDSN 17 establishes a PPP session for the MT 5. Afterwards, the BSC 10 sends an Origination reply 150 to the MT 5 for responding to the Origination request 102.

Alternatively, the network operator may decide to merely upgrade an existing network and with PANA/PPP capable PDSNs that support both PANA and PPP. However, existing MTs may only be PPP capable or PANA capable. In this case, it could be interesting for the PDSN to know what type of MT is attempting to connect to the network and therefore start or establishes an appropriate network access procedure between a PANA session and PPP session. For that reason, the algorithm 200 cannot be applied.

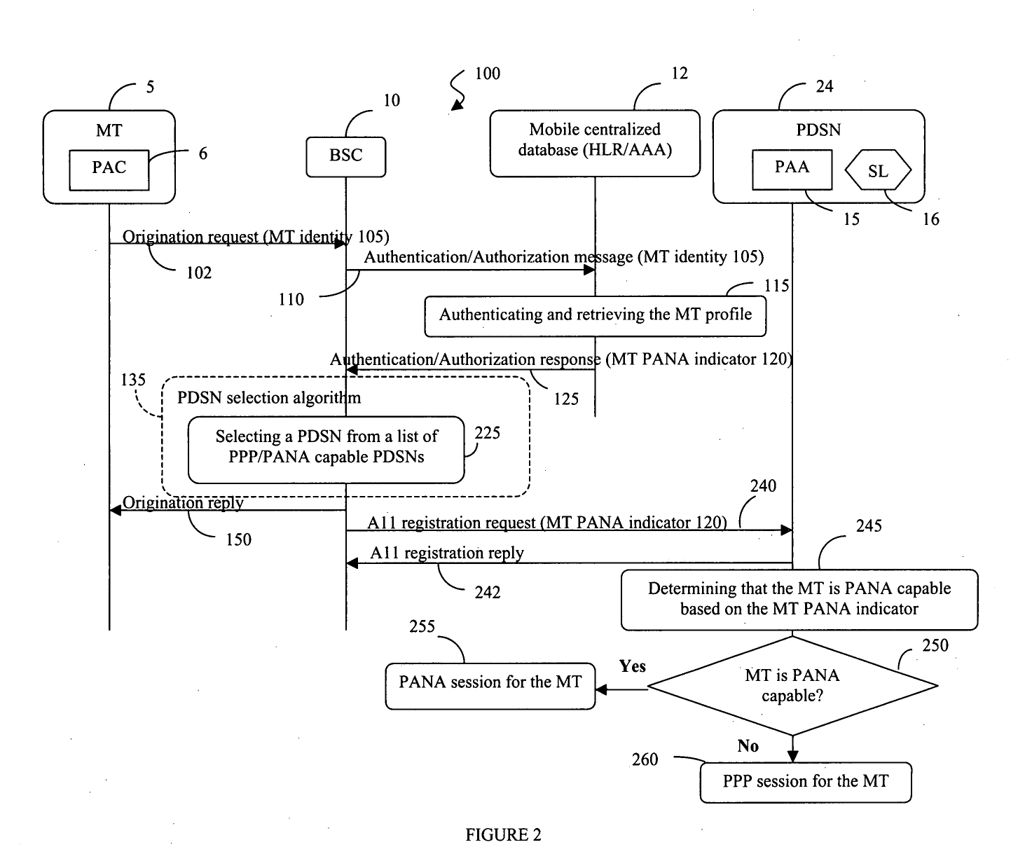

Reference is now made to FIG. 2, which is a nodal operation and signal flow diagram illustrating a flow of messages of a method for providing network access to the MT 5 when a PDSN supports both PANA and PPP in the packet data network 100 in accordance to the invention. In FIG. 2, the BSC 10 performs a PDSN selection algorithm 135 instead of the PDSN selection algorithm 200 of FIG. 1. The PDSN algorithm 135 uses the received MT PANA capability indicator 120 for selecting from the list 38 of PANA/PPP PDSN IP addresses a PPP/PANA capable PDSN (step 225). The BSC 10 further uses the identity 105 of the MT 5 for selecting the PPP/PANA capable PDSN 24. More precisely, the PDSN selection algorithm 135 is performed at the BSC 10 by hashing the identity 105 of the MT 5.

The PDSN 24 comprises a service logic (SL) 16 adapted for receiving and sending messages to network elements such as the BSC 10 in the packet data network 100 or the MT 5. The SL 16 further operates the PDSN 24. The service logic 16 can be a software, a hardware or any combination thereof. The PDSN 24 further comprises a PANA Authentication Agent (PAA) 15 for starting a PANA session with a MT that comprises a PANA Client (PAC) and that therefore supports PANA.

Following the selection, the BSC 10 sends to the selected PDSN 24 an A11 registration request 240 that includes the MT PANA capability indicator 220 to the PDSN 24. The A11 registration request 240 is sent for requesting packet data services and for granting network access to the MT 5. The PDSN 24 via its SL 16 receives the A11 registration request 240 that includes a MT PANA indicator 220. The PDSN 24 replies to the A11 Request by sending an A11 registration reply 242 to the BSC 10. Based on the received MT PANA capability indicator 120, the SL 16 determines that the MT 5 is PANA capable (step 245). At step 250, if the MT 5 is PANA capable, the PDSN 24 via its SL 16 starts a PANA session (step 255). However, if the SL 16 determines that the MT 5 is not PANA capable, the PDSN 24 establishes a PPP session (step 260).

Since the PDSN 24 already knows that the MT 5 is PANA capable or not, the BSC 10 may not send the MT PANA capability indicator 120 to the selected PDSN 24. Also, in the absence of a MT PANA capability parameter 120, the PDSN 24 assumes that the MT 5 is only PPP capable.

It can be understood that some messages and therefore some parameters sent from the MT 5 to the packet data network 100 and vice versa are not mentioned nor described for clarity reasons. Also some messages and therefore some parameters sent between network elements such as the BSC 10, the centralized database 12 and the PDSN 14, 17 and 24 in the packet data network 100 are omitted for clarity reasons. More particularly, it should also be understood that FIGS. 1-3 each depicts a simplified packet data network 100, and that many other nodes have been omitted for clarity reasons only.

What is claimed is:

1. A method for providing network access to a mobile terminal (MT) in a packet data network, the method comprises steps of:
receiving at a base station controller (BSC) from the MT an origination request for requesting packet data services in the packet data network, the origination request including the identity of the MT;
sending from the BSC to a mobile centralized database of the MT an authorization/authentication message that includes the identity of the MT;
receiving at the BSC from the mobile centralized database an authorization/authentication response, the authorization/authentication response including a MT protocol for carrying authentication for network access (PANA) capability indicator, wherein the MT PANA capability indicator indicates whether or not the MT is PANA capable;
performing a selection algorithm at the BSC for selecting from a first list of IP addresses of PANA capable PDSNs and a second list of point-to-point protocol (PPP) capable PDSNs a PDSN for serving the MT:
determining, based on the received MT PANA capability indicator, whether or not the MT is PANA capable;
if the MT PANA indicator indicates that the MT is PANA capable, the BSC selects a PANA capable PDSN from the first list; and
if the MT PANA indicates that the MT is not PANA capable, the BSC selects a PPP capable PDSN from the second list.

2. The method of claim 1 further comprises steps of:
sending from the BSC to the selected PDSN an A11 registration request that includes the MT PANA capability indicator:
if the selected PDSN is a PANA capable PDSN, starting at the selected PANA capable PDSN a PANA session for the MT; and
if the selected PDSN is a PPP capable PDSN, establishing at the selected PPP capable PDSN a PPP session for the MT.

3. The method of claim 1, wherein the step of performing further includes a step of sending from the BSC to the MT an origination reply for responding to the origination request.

4. The method of claim 1, wherein the step of sending from the BSC to the mobile centralized database an authorization/authentication message includes the steps of:
authenticating the MT, based the received MT identity, at the at the mobile centralized database; and
retrieving at the mobile centralized database in a MT profile of the MT the MT PANA capability indicator.

5. A base station controller (BSC) for selecting a packet data serving node (PDSN), wherein the base station comprises:
a service logic adapted for:
receiving at the BSC from the mobile centralized database an authorization/authentication response, the authorization/authentication response including a MT protocol for carrying authentication for network access (PANA) capability indicator, wherein the MT PANA capability indicator indicates whether or not the MT is PANA capable;
a database adapted for:
storing a first list of PANA capable PDSN and a second list of PPP capable PDSN;
wherein the service logic performs a selection algorithm at the BSC for selecting a PDSN from a first list of IP addresses of PANA capable PDSNs and a second list of PPP capable PDSNs, wherein the selection is based on the received MT PANA capability indicator:
if the MT PANA indicator indicates that the MT is PANA capable, the service logic selects a PANA capable PDSN from the first list; and
if the MT PANA indicator does not indicate that the MT is PANA capable, the service logic selects a PPP capable PDSN from the second list.

6. The BSC of claim 5, wherein the service logic further sends to the mobile centralized database an authorization/authentication message that includes the identity of the MT.

7. The BSC of claim 5, wherein the first list also contains PPP/PANA capable PDSNs.

8. The BSC of claim 5, wherein the BSC further determines that the MT is or not PANA capable prior to performing the PDSN selection algorithm.

9. The BSC of claim 5, wherein the BSC further sends sending to the MT an origination reply for responding to the origination request.
